(19) United States
(12) Patent Application Publication
(10) Pub. No.: US 2005/0184485 A1
(43) Pub. Date: Aug. 25, 2005

(54) Folding trailer with kneeling device

(76) Inventor: Joseph Timmermans, Ortonville, MI (US)

Correspondence Address: YOUNG & BASILE, P.C., 3001 WEST BIG BEAVER ROAD, SUITE 624, TROY, MI, 48084, US

(21) Appl. No.: 11/057,601

(22) Filed: Feb. 14, 2005

Related U.S. Application Data
(60) Provisional application No. 60/544,890, filed on Feb. 13, 2004.

(51) Int. Cl. B60D 1/00; B62D 21/14

(52) U.S. Cl. 280/656; 280/43.1

(57) ABSTRACT

A preferred embodiment of a folding trailer with kneeling device is disclosed. The trailer includes a kneeling mechanism that is moveable between a traveling position and a kneeling position. The kneeling mechanism includes a pair of control arms that are cantilevered from the ends of a tubular control shaft. The control shaft is hingeably connected to a frame of the trailer. At least one hydraulically actuated cylinder is used to control the positioning of the kneeling mechanism with respect to the frame of the trailer. Placing the kneeling mechanism place in the kneeling position causes the trailer edge of the trailer to be positioned proximate to the ground to facilitate loading and unloading of the trailer.

### RELATED APPLICATIONS

This application is a continuation of U.S. Provisional Application Ser. No. 60/544,890 filed Feb. 13, 2004.

### FIELD OF THE INVENTION

The present invention relates in general to trailers, and in more particularly to a folding trailer having a kneeling device for moving the trailer between a traveling position and a kneeling position.

### BACKGROUND OF THE INVENTION

Trailers come in various sizes and shapes and are useful for transporting a wide variety of cargo, including motorcycles, all-terrain vehicles, boats, personal water craft, household goods, and the like. Trailers typically include a bed supported by a frame. At least one axle shaft is attached to the underside of the frame. A pair of wheels and tires are attached to the ends of the axle shaft. An elongated tongue extends from the front of the frame and includes a device for attaching the trailer to a tow vehicle.

A problem typically associated with trailers is how to conveniently and safely load and unload the trailer. The frame of the trailer is typically mounted above the axle shaft, which can result in a significant distance between the ground and the trailer bed depending on the diameter of the trailer's tires. The greater the distance between the ground and the bed of the trailer, the more difficult it may be to load and unload cargo from the trailer. To overcome this limitation, some trailer designs utilize small diameter tires and wheels to minimize the distance between the ground and the bed of the trailer. But because small diameter wheels rotate faster than large diameter wheels for a given vehicle speed, small diameter wheels may require the use of more costly components, such as wheel bearings, that can withstand the increased stress and thermal loads that may occur when the trailer is being towed. Furthermore, trailers using small wheels may be less stable when being towed than a trailer utilizing larger wheels.

It is also known to use ramps for providing more convenient access to the trailer bed. A disadvantage of ramps, however, is that the ramps typically need to transported with the trailer so as to be available when needed. Furthermore, in order to minimize the ramp angle, it is desirable to utilize as long a ramp as possible. Unfortunately, longer ramp lengths merely exacerbate the problem of storing and transporting the ramps. Shorter ramp lengths, on the other hand, are more convenient to store and transport, but may result in a ramp angle that is difficult to negotiate.

Prior inventions have attempted to overcome these limitations by designing a trailer that includes a bed having a tiltable section that enables the rear end to the trailer to drop to the ground while the remaining portion of the bed is maintained in a traveling position. Although such designs eliminate many of the problems associated with using ramps, the designs typically result in ramp angles that may nevertheless be difficult to negotiate. Accordingly, it is desirable to develop a trailer that has a sufficiently shallow ramp angle that can be conveniently negotiated when loading an unloading cargo to and from the trailer.

### SUMMARY OF THE INVENTION

In accordance with the present invention, a preferred embodiment of a folding trailer with kneeling device is disclosed. The trailer includes a kneeling mechanism that is moveable between a traveling position and a kneeling position. The kneeling mechanism includes a pair of control arms that are cantilevered from the ends of a tubular control shaft. The control shaft is hingeably connected to a frame of the trailer. At least one hydraulically actuated cylinder may be used to control the positioning of the kneeling mechanism with respect to the frame of the trailer. Alternatively, the kneeling mechanism may also be operated using another device, such as a lead screw, cable and pulley system, rack and pinion, linear actuating cylinder, gear set, or the like. Placing the kneeling mechanism in the kneeling position causes the trailing edge of the trailer to be positioned proximate to the ground to facilitate loading and unloading of the trailer.

The kneeling mechanism may also incorporate an elastomer spring mechanism that is disposed within the control shaft. The spring mechanism includes an elongated suspension shaft and a plurality of elastomer spring members disposed between the inner periphery of the control shaft and the outer periphery of the suspension shaft. Rather than attaching the control arms to the ends of the control shaft, the control arms are attached to the ends of the suspension shaft. The elastomer springs operate to resist rotation of the suspension shaft about its longitudinal axis.

Another aspect of the present invention includes the ability to compactly store the trailer in an upright position. This is accomplished by placing the kneeling mechanism in its kneeling position and folding an aft section of the trailer onto a forward section of the trailer. The trailer can be stored by standing the trailer on end with a tongue of the trailer extending in a generally vertical direction.

Further areas of applicability of the present invention will become apparent from the detailed description provided hereinafter. It should be understood the detailed description and specific examples, while indicating the preferred embodiment of the invention, are intended for purposes of illustration only and are not intended to limit the scope of the invention.

### BRIEF DESCRIPTION OF THE DRAWINGS

The description herein makes reference to the accompanying drawings, wherein like reference numerals refer to like parts throughout the several views, and wherein:

FIG. 1 is a top right rear perspective view of a trailer having a preferred embodiment kneeling mechanism shown disposed in a traveling position, with the right fender removed for clarity;

FIG. 2 is a top right rear perspective view of the trailer shown in FIG. 1 with a deck of the trailer removed for clarity;

FIG. 3 is a fragmentary right elevational view of the trailer, with the right wheel, tire, and fender removed for clarity, showing the preferred embodiment kneeling mechanism disposed in the traveling position;

FIG. 3A is a fragmentary right elevational view of the trailer having an elastomer suspension system, with the right wheel, tire, and fender removed for clarity, showing the preferred embodiment kneeling mechanism disposed in the traveling position;

FIG. 4 is a fragmentary bottom perspective view of the trailer, with the right wheel, tire, and fender removed for clarity, showing the preferred embodiment kneeling mechanism disposed in the traveling position;

FIG. 5 is a cross sectional view of the trailer taken along line 5-5 of FIG. 2, showing the elastomer suspension system employable with the preferred embodiment kneeling mechanism;

FIG. 5A is a fragmentary sectional view of the elastomer suspension system employable with the preferred embodiment kneeling mechanism;

FIG. 6 is a right elevational view of the trailer showing the preferred embodiment kneeling mechanism disposed in a kneeling position;

FIG. 7 is a fragmentary right elevational view of the trailer, with the right wheel, tire, and fender removed for clarity, showing the preferred embodiment kneeling mechanism disposed in the kneeling position;

FIG. 8 is a fragmentary bottom perspective view of the trailer, with the right wheel, tire, and fender removed for clarity, showing the preferred embodiment kneeling mechanism disposed in the kneeling position;

FIG. 9 is a top right rear perspective view of the trailer shown in a partially folded position, with the decking, right wheel, tire, and fender removed for clarity, and the preferred embodiment kneeling mechanism disposed in the kneeling position;

FIG. 10 is a top right rear perspective view of the trailer shown in a folded position, with the decking, right wheel, tire, and fender removed for clarity, and the preferred embodiment kneeling mechanism disposed in the kneeling position; and

FIG. 11 is a perspective view of the folded trailer, with the decking, right wheel, tire, and fender removed for clarity, shown positioned in an upright position for storage.

### DETAILED DESCRIPTION OF THE PREFERRED EMBODIMENT

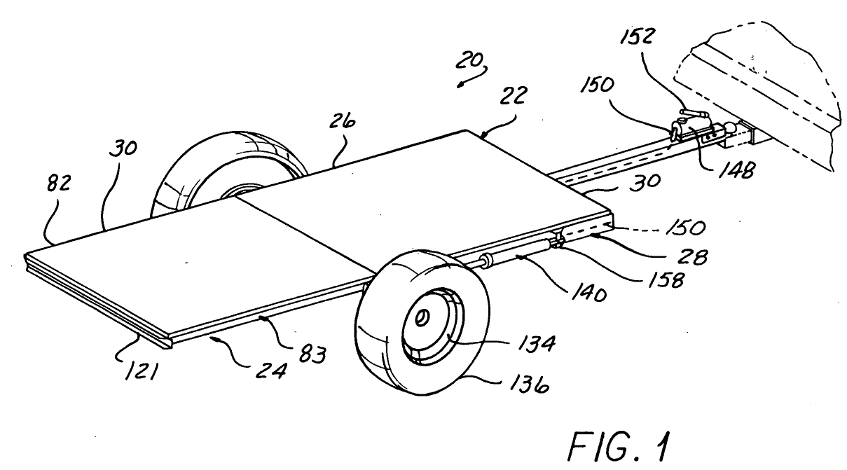

Referring to FIG. 1, a trailer 20 is shown to include a forward section 22 and an aft section 24 hingeably attached to the forward section 22. Hingeably attaching the forward section 22 to the aft section 24 enables the aft section to be folded onto the forward section for compactly storing the trailer 20 in an upright position.

The forward section 22 of the trailer 20 includes a deck 26 supported by a frame 28. Although deck 26 is shown to have a rectangular shape, it shall be understood that deck 26 may have a variety of other geometric shapes depending on the requirements of the particular application for which the trailer may be used. Deck 26 is preferably made of a material having sufficient structural strength to support a predetermined maximum load to be supported by trailer 20. The deck material will preferably be resistant to environmental effects that may tend to degrade the aesthetic and/or structural properties of the material, such as rain, snow, ultraviolet radiation, salt and other road contaminants, and the like. Suitable materials may include steel having a protective surface coating, aluminum, composite materials, structural plywood, and the like. Deck 26 may be removably attached to frame 28 using fasteners 30, which may include bolts, rivets, screws, clips, and the like. Alternatively, deck 26 may be secured to frame 28 by welding or using structural adhesives where appropriate.

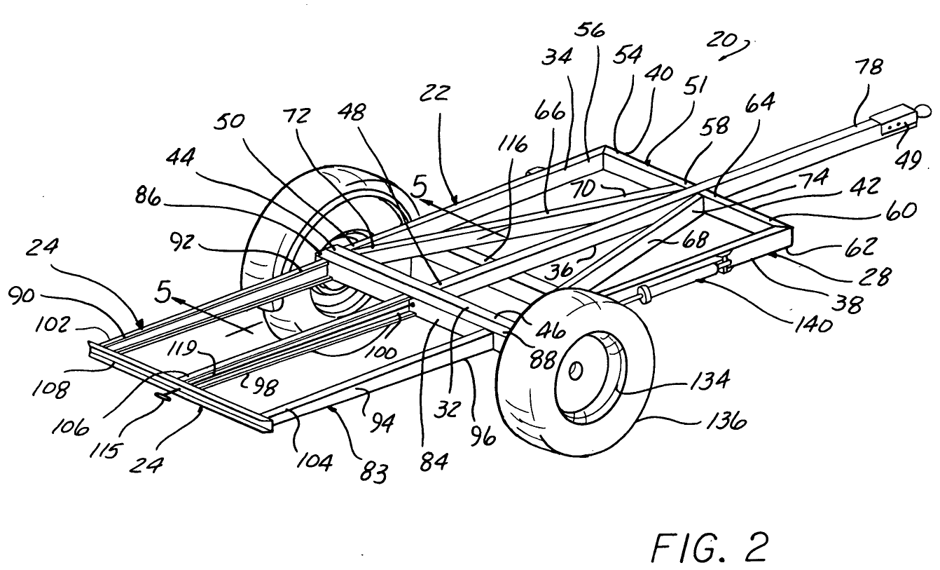

Referring also to FIG. 2, frame 28 is constructed from a plurality of interconnected hollow tubular beams. The beams support deck 26 and provide trailer 20 with sufficient structural strength and rigidity to adequately support a cargo loaded on the trailer. Although the beams are shown to have a generally rectangular cross sectional shape, other cross sectional shapes may be used with equally satisfactory results, such as I-beams, C-channels, L-channels, circular, and the like.

Forward section 22 of frame 28 includes an aft beam 32, a left side beam 34, a center beam 36, a right side beam 38, a left forward beam 40, and a right forward beam 42. Aft beam 32 has its longitudinal axis positioned substantially perpendicular to a longitudinal axis of trailer 20 and includes a left end 44 and a right end 46. Center beam 36 has an aft end 48 fixedly attached to aft beam 32 approximately midway between left end 44 and right end 46. A longitudinal axis of center beam 36 is aligned substantially perpendicular to the longitudinal axis of aft beam 32 so as to form a generally T-shaped configuration. A forward end 49 of beam 36 extends forward of a front end 51 of trailer 20.

An aft end 50 of left side beam 34 is fixedly attached to aft beam 32 proximate to left end 44. Left side beam 34 is positioned such that its longitudinal axis is aligned substantially perpendicular to the longitudinal axis of aft beam 32 and substantially parallel to the longitudinal axis of center beam 36.

An aft end 52 (best viewed in FIG. 9) of right side beam 38 is fixedly attached to aft beam 32 proximate to right end 46. Right side beam 38 is positioned such that its longitudinal axis is aligned substantially perpendicular to the longitudinal axis of aft beam 32 and substantially parallel to the longitudinal axis of center beam 36.

Left forward beam 40 has an end 54 fixedly attached to a forward end 56 of left side beam 34. An opposite end 58 of left forward beam 40 is attached to center beam 36 at a point between aft end 48 and forward end 49. A longitudinal axis of left forward beam 40 is aligned substantially perpendicular to the longitudinal axis of both center beam 36 and left side beam 34.

Right forward beam 42 has an end 60 fixedly attached to a forward end 62 of right side beam 38. An opposite end 64 of right forward beam 42 is attached to center beam 36 at a point between aft end 48 and forward end 49. A longitudinal axis of right forward beam 42 is aligned substantially perpendicular to the longitudinal axis of both center beam 36 and right side beam 38.

Forward section 22 may further include a left lateral support member 66 and a right lateral support member 68. Lateral support members 66 and 68 operate to limit lateral movement of center beam 36 when forward end 49 of center beam 36 is subjected to lateral loads, such as which may occur when trailer 20 is being towed behind a vehicle. Lateral support 66 is positioned within a rectangular box defined by left side beam 34, left forward beam 40, center beam 36, and the aft beam 32. An end 70 of left lateral support 66 is fixedly attached near end 58 of left forward beam 40 adjacent center beam 36. An opposite end 72 is fixedly attached to aft beam 32 adjacent end 50 of left side beam 34.

Lateral support 68 is positioned within a rectangular box defined by right side beam 38, right forward rail 42, center beam 36, and the aft beam 32. An end 74 of lateral support 68 is fixedly attached to end 64 of forward beam 42 and an opposite end 76 (best viewed in FIG. 9) is fixedly attached to aft beam 32 adjacent end 52 of left side beam 38.

A forward section of center beam 36 extends beyond right and left forward beams 40 and 42, respectively, to form a tongue 78 of trailer 20. Attached to forward end 49 of tongue 78 is a known device 80 for attaching trailer 20 to the tow vehicle.

Aft section 24 of trailer 20 further includes a deck 82 supported by a frame 83. Although deck 82 is shown to have a generally rectangular shape, it shall be understood that deck 82 may have a variety of other geometric shapes depending on the requirements of the particular application for which the trailer may be used. Similar to forward deck 26, deck 82 is also preferably made of a material having sufficient structural strength to support a predetermined maximum load to be supported by trailer 20. The deck material will preferably be resistant to environmental effects that may tend to degrade the aesthetic and/or structural properties of the material, such as rain, snow, ultraviolet radiation, salt and other road contaminants, and the like. Suitable materials may include steel having a protective surface coating, aluminum, composite materials, structural plywood, and the like. Deck 82 may be removably attached to the frame 84 using fasteners 30, which may include bolts, rivets, screws, clips, and the like. Alternatively, deck 82 may be secured to frame 83 by welding or using structural adhesives where appropriate.

Frame 83 is constructed from a plurality of interconnected beams. The beams support deck 82 and provide sufficient structural strength and rigidity to adequately support cargo loaded on the trailer. As is the case with forward frame 28, the beams of frame 83 may have any of a variety of cross section shapes, including but not limited to, I-beams, C-channels, L-channels, circular, and the like.

Frame 83 includes a forward beam 84 having a left end 86 and a right end 88. A left side beam 90 has a forward end 92 fixedly attached to forward beam 84 proximate to end 86 of beam 84. A right side beam 94 has a forward end 96 fixedly attached to forward beam 84 proximate to end 88 of forward beam 84. Positioned between right and left side beams 90 and 94, respectively, is a center beam 98 having a forward end 100 fixedly attached to forward beam 84 midway between ends 86 and 88. Attached to an aft end 102 of left side beam 90, and an aft end 104 of right side beam 94, and an aft end 106 of center beam 98, is an aft beam 108.

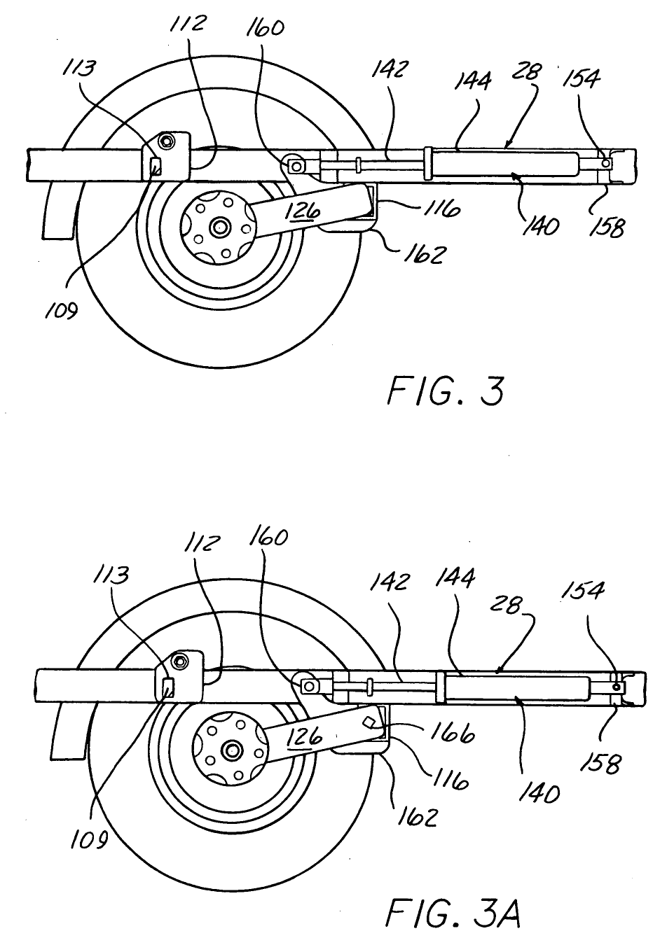

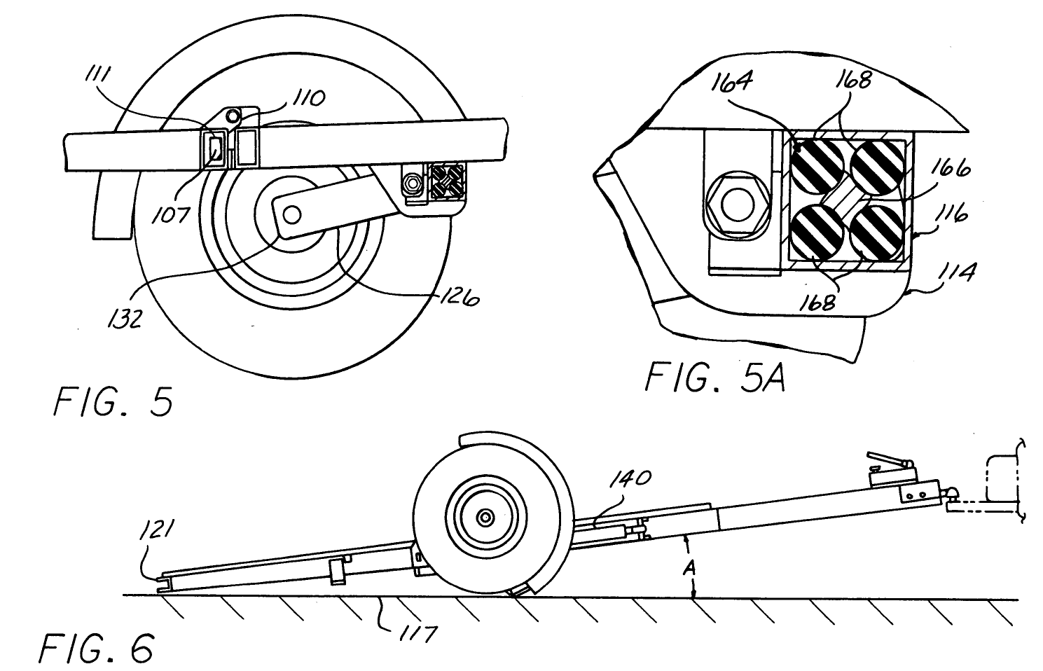

Referring also to FIGS. 3 and 5, a forward edge of aft frame 83, defined by forward beam 84, is hingeably attached to an aft edge of forward frame 28, defined by aft beam 32, by means of a pair of hinges 110 and 112. Hinge 110 is attached to left end 86 of beam 84 and left end 44 of beam 32. Hinge 112 is attached to right end 88 of beam 84 and right end 46 of beam 32.

Forward and aft sections 22 and 24 of trailer 20 are locked in a non-folded traveling position, as shown in FIG. 2, by engaging a pin 107 located at the left end 86 of beam 84 with an aperture 111 disposed in left hinge 110, and a pin 109 located at the right end 88 of beam 84 with an aperture 113 disposed in right hinge 112. A biasing device urges pins 107 and 109 into engagement with aperture 111 and 113, respectively. Each pin 107 and 109 is attached to a cable 119 that can be routed from the pins to the aft end 106 of beam 98. A handle 115 is provide at the end of cable 119. Pins 107 and 109 can be disengage from apertures 111 and 113 by grasping handle 115 and pulling the handle rearward. This causes pins 107 and 109 to be withdrawn from apertures 111 and 113, thereby enabling aft section 24 to be folded onto the forward section 22.

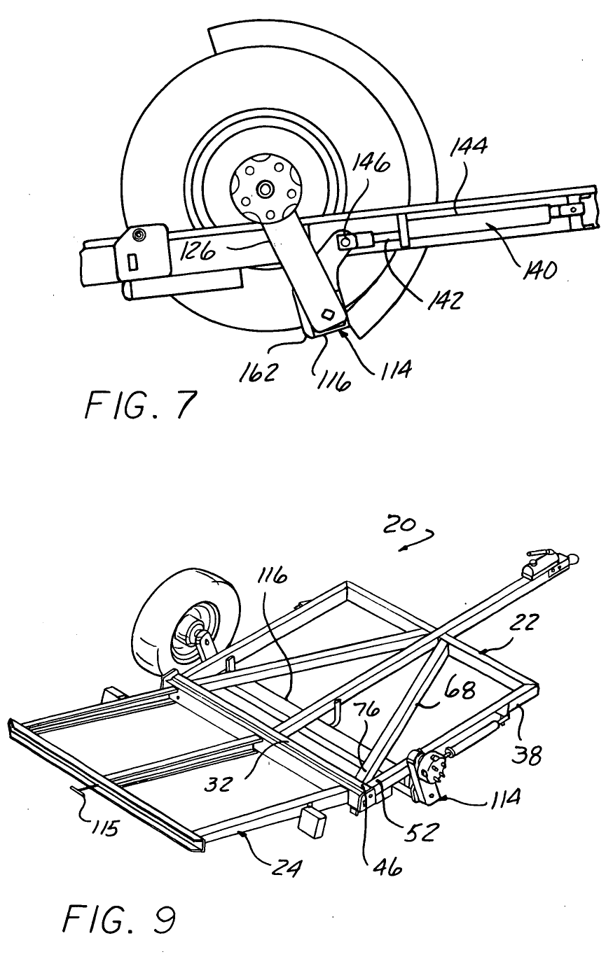

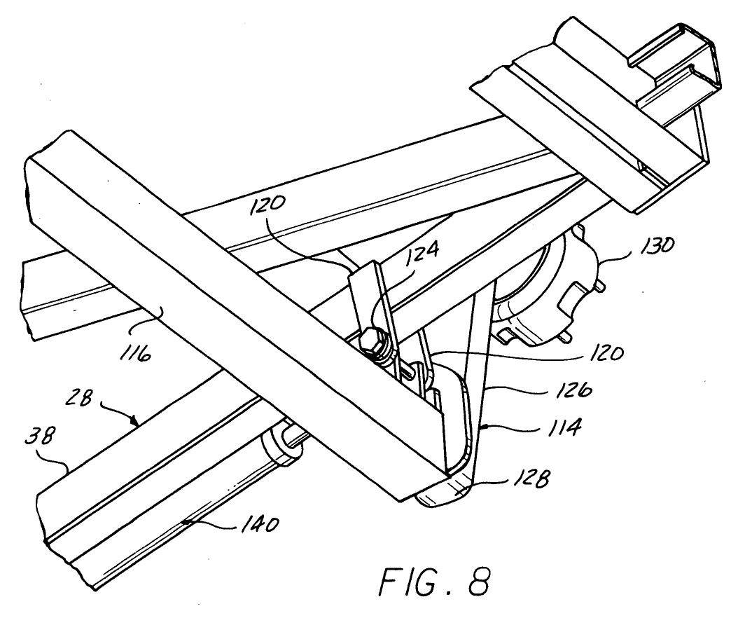

Referring to FIGS. 3-5, 7, and 8, trailer 20 includes a kneeling mechanism 114 for enabling a user to selectively change the positioning of the wheels of the trailer with respect to the bed of the trailer. Kneeling mechanism 114 is moveable between a traveling position, as shown in FIGS. 3-5, and a kneeling position, as shown in FIGS. 7 and 8. Kneeling mechanism 114 enables trailer 20 to be tilted to allow trailing edge 121 of the trailer to be positioned in close proximity to the ground 117, as shown in FIG. 6. With trailing edge 121 of the trailer positioned adjacent to the ground, a user can conveniently load or unload the trailer without the need for additional ramps or lifting devices.

Kneeling mechanism 114 includes an elongated tubular control shaft 116 hingeably attached to frame 28 of trailer 20. Control shaft 116 may have a generally rectangular cross-sectional shape, or another cross-sectional shape, such as triangular, circular, or hexagonal, for example. Although control shaft 116 preferably has a tubular configuration, the control shaft may alternatively have a solid core.

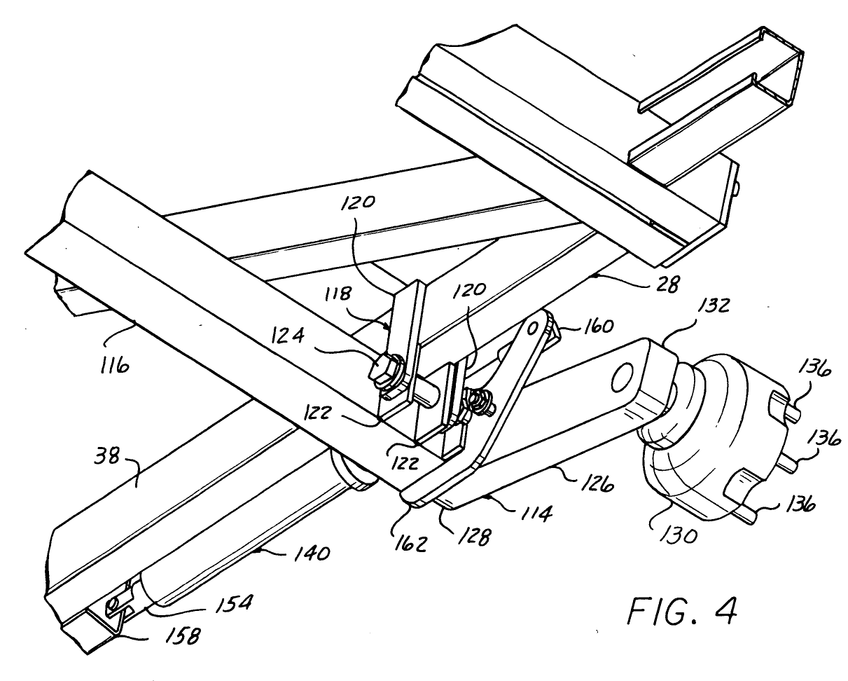

Control shaft 116 can be positioned with respect to trailer 20 such that a longitudinal axis of the shaft is aligned substantially perpendicular to the longitudinal axis of the trailer. As best viewed in FIG. 4, a hinge 118 can connect one end of control shaft 116 to frame 28. Hinge 118 includes a pair of links 120, which are suitably attached to right beam 38 of frame 28, such as by welding, bolting, riveting, screwing, and the like. Hinge 118 further includes a second pair of links 122, which are fixedly attached to control shaft 116. Links 122 may be attached to control shaft 116 using any suitable method, such as welding, bolting, riveting, screwing, and the like. Hinge links 120 and 122 can be pivotally connected to one another using a bolt 124, or another suitable attaching means, such as a pin, rivet, screw, and the like. A second hinge 118 can be used to attach the opposite end of control shaft 116 to left side beam 34 of frame 28 in a like manner.

Continuing to refer to FIG. 4, attached perpendicularly to the right end of control shaft 116 is an elongated control arm 126. Control arm 126 is cantilevered from a right end of control shaft 116 by attaching a first end 128 of the control link to the end of control shaft 116. The cantilevered control arm 126 extends in a generally aft direction when kneeling mechanism 114 is positioned in the traveling position.

A wheel hub 130 is suitably attached to a second end 132 of control arm 126. A rotational axis of hub 130 is aligned substantially perpendicular to a longitudinal axis of control arm 126. A wheel rim 134 (see FIGS. 1 and 2) having a tire 136 is fixedly attached to hub 130 in a known manner by positioning wheel rim 134 adjacent hub 130 such that wheel lugs 136 pass through corresponding holes in wheel rim 134. Wheel rim 134 is secured to hub 130 by threadably engaging a lug nut (not shown) with each wheel lug 136. For purposes of clarity, wheel rim 134 and tire 136 are not shown in FIGS. 4 and 8, but can be viewed in FIGS. 1 and 2.

Attached to the left end of control shaft 116 is a second set of components, including control arm 126, hub 130, wheel rim 134, and tire 136, which mirrors the components attached to the right end of control shaft 116.

Referring to FIGS. 1, 3 and 4, control shaft 116 can be pivotally rotated about hinge bolt 124 of hinge 118 by means of a hydraulic cylinder 140. Alternatively, the kneeling mechanism may also be operated using another device, such as a lead screw, cable and pulley system, rack and pinion gear, linear actuating cylinder, gear set, and the like. Hydraulic cylinder 140 includes a piston 142, which is movable within a cylinder sleeve 144 between a retracted position (as shown in FIG. 7) and an extended position (as shown in FIG. 3). A hydraulic pump 148 provides pressurized hydraulic fluid for actuating hydraulic cylinder 140. Hydraulic lines 150 fluidically connect pump 148 to hydraulic cylinder 140. Hydraulic lines 150 may be routed along an outside surface of frame 28, or through the hollow interior of the frame beams. Pump 148 can be manually actuated by means of pump handle 152. Alternatively, pump 148 can be configured to operate automatically by incorporating an electric motor or another similar device to drive the hydraulic pump.

Referring to FIG. 3, an end 154 of hydraulic cylinder sleeve 144 is pivotally attached to a bracket 158. Bracket 158 can be attached to frame 28 by welding, bolting, screwing, or any other suitable attaching method. An exposed end 160 of piston 142 is pivotally attached to one end of a lever arm 162. An opposite end of lever arm 162 is fixedly attached to control shaft 116.

A second actuating system having a second hydraulic cylinder 140 and a second lever arm 162 can be attached in the similar manner to the left side of frame 28 and the left end of control shaft 116. Hydraulic line 150 can be branched to fluidically connect the second hydraulic cylinder to pump 148. It shall be appreciated, however, that only one actuating system may be required to properly operate kneeling mechanism 114, depending on various factors, including but not limited to, the size of the trailer, the load carrying capacity of the trailer, and the maximum pressure developed by the hydraulic pump.

Kneeling mechanism 114 is operable to move trailer 20 between the traveling position, as shown in FIG. 1, and the kneeling position, as shown in FIG. 6. Trailer 20 can be positioned in the traveling position by operating pump 148 to pressurize the hydraulic fluid present in the hydraulic system. Doing so causes piston 142 to telescopically extend from sleeve 144 of hydraulic cylinder 140, which in turn rotates kneeling mechanism 114 in a counterclockwise direction (as viewed from the right side of the trailer) about hinge bolt 124 of hinge 120, thereby moving kneeling mechanism 114 to the traveling position.

Trailer 20 can be positioned in the kneeling position, as shown in FIG. 6, to facilitate loading and unloading of the trailer. In this position, trailing edge 121 of trailer 20 is positioned in close proximity to the ground. The bed of trailer 20 is also positioned at a relatively shallow angle “A” relative the ground. To position the trailer in the kneeling position, a known device associated with the hydraulic system can be activated, such as a pressure relief valve, that allows pressure within the hydraulic system to dissipate. This causes piston 142 to retract within sleeve 144. Retracting piston 142 causes kneeling mechanism 114 to rotate in a clockwise direction (as viewed from the right side of the trailer) about hinge bolt 124 of hinge 120 and into the kneeling position as shown in FIG. 7. Trailer 20 can be returned to the traveling position by performing the previously described steps for pressurizing the hydraulic system and extending piston 142.

Referring to FIGS. 3a and 5, kneeling mechanism 114 may also incorporate an elastomer suspension system 164. Suspension system 164 includes a generally square-shaped elongated suspension shaft 166 disposed within control shaft 116. Disposed between an outer periphery of suspension shaft 166 and an inside periphery of control shaft 116 are four cylindrical elastomer springs 168. Elastomer springs 168 are located adjacent the corners of control shaft 116. An outer periphery of elastomer springs 168 contact both the inside surface of control shaft 166 and the outer periphery of suspension shaft 166. Suspension shaft 166 preferably has a longer length than control shaft 116 to allow the ends of suspension shaft 166 to extend beyond both ends of control shaft 116. End 128 of control arm 126 can then be attached to opposite ends of suspension shaft 166 rather than the ends of control shaft 116.

Elastomer suspension system 164 operates to resist rotational movement of suspension shaft 166 about its longitudinal axis. Applying a load to end 132 of control arm 126 will tend to cause suspension shaft 166 to rotate about its longitudinal axis. Rotation of suspension shaft 166, however, is resisted by elastomer elements 168, which create an interference between control shaft 116 and suspension shaft 166. The amount of rotation of suspension shaft 166 for a given load may vary depending on the elastic properties of elastomer elements 168.

Referring to FIGS. 9-11, trailer 20 can be folded and stored in an upright position requiring a minimal amount of floor space for storage. For purposes of clarity, trailer 20 is shown in FIGS. 9-11 with right wheel rim 136, tire 136, and decking 26 and 82 removed in order to view the positioning of the kneeling mechanism 114 and various frame components during the folding operation. It shall be understood, however, that it is not necessary the decking and the right wheel and tire be removed in order to position the trailer in the stored position.

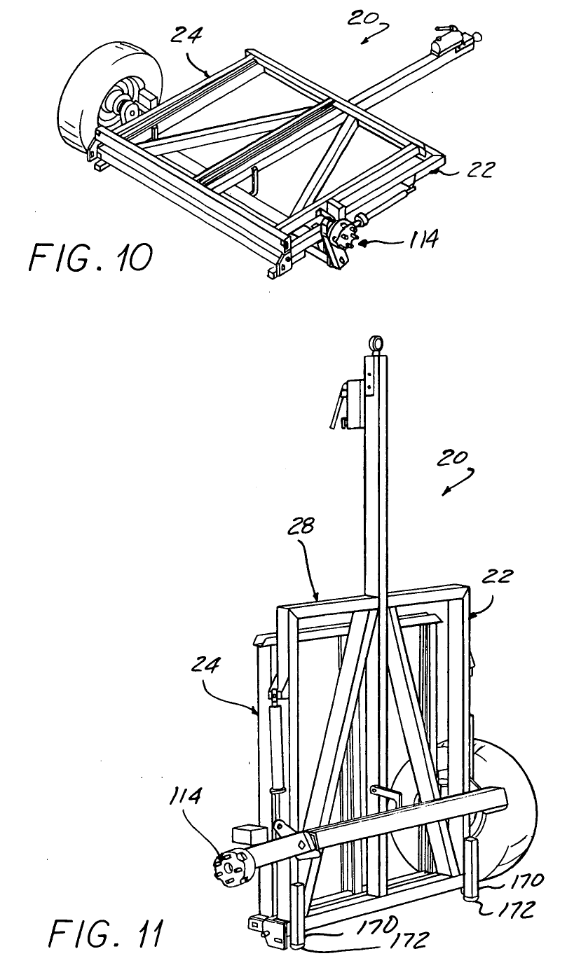

To configure trailer 20 for storage, kneeling mechanism 114 is first placed in the kneeling position. Aft section 24 of trailer 20 is then folded onto forward section 22. This can be accomplished by grasping handle 115 and pulling the handle in a rearward direction to disengage pins 107 and 109 from apertures 111 and 113 in left and right hinges 110 and 112, respectively. With pins 107 and 109 disengaged from apertures 111 and 113, aft section 24 can be pivoted onto forward section 22 of trailer 20, as shown in FIGS. 9 and 10. With kneeling mechanism 114 placed in the kneeling position and aft section 24 of trailer 20 folded onto forward section 22, trailer 20 can be stood in an upright position for storage, as shown in FIG. 11. A pair of legs 170 can be suitably attached to frame 28. Trailer 20 rests on an end 172 of legs 170 and tires 136 when positioned in the upright storage position.

The description of the invention is merely exemplary in nature, and thus, variations that do not depart from the gist of the invention are intended to be within the scope of the invention. Such variations are not intended to be regarded as a departure from the spirit and scope of the invention.

1. A trailer comprising:
a trailer frame;
an elongated control arm having a first end operably connected to the trailer frame for pivotal rotation thereabout, and an opposing second end, the control arm is selectively movable between in a traveling position and a kneeling position; and
a wheel hub rotatably attached to the second end of the control arm.

2. The trailer of claim 1 further comprising a lever arm operably connected to the control arm for concurrent rotation therewith about a common axis; and
means for selectively moving the control arm between the traveling position and the kneeling position, the moving means having one end operably connected to the control arm and a second end operably connected to the trailer frame.

3. The trailer of claim 2, wherein the moving means comprises a hydraulic cylinder having one end attached to the frame and a second end attached to the control arm, the hydraulic cylinder being operable between a retracted position and an extended position.

4. The trailer of claim 3, wherein the control arm is positioned in the traveling position when the hydraulic cylinder is in the extended position.

5. The trailer of claim 2, wherein the connection between the moving means and the lever arm is displaced from the control arm and cantilevered from the axis of rotation of the control arm.

6. The trailer of claim 1 further comprising an elongated member pivotably connected to the frame and having a longitudinal axis aligned substantially perpendicular to a longitudinal centerline of the trailer, the control arm operably connected to one end of the elongated member.

7. The trailer of claim 6 further comprising a second control arm operably connected to a second end of the elongated member.

8. The trailer of claim 7, wherein a longitudinal axis of the first control arm is aligned substantially parallel to a longitudinal axis of the second control arm.

9. The trailer of claim 6, wherein a longitudinal axis of the elongated member is displaced from the elongated member's pivoting connection to the frame.

10. The trailer of claim 1, wherein the trailer frame comprises:
a forward section having an upper surface and a lower surface and an aft section hingeably connected to the forward section, the aft section having an upper surface and a lower surface, wherein the aft section may be rotated about its pivot connection to the forward section and into a position whereby the upper face of the forward section is positioned adjacent the upper face of the aft section.

11. The trailer of claim 1, wherein an axis of rotation of the wheel hub is positined below the upper surface of the trailer frame when the control arm is positioned in the traveling position.

12. The trailer of claim 1, wherein an axis of rotation of the wheel hub is positioned above the upper surface of the trailer frame when the control arm is positioned in the kneeling position.

13. The trailer of claim 1, wherein the control arm is infinitely positionable between the traveling position and the kneeling position.

14. The trailer of claim 1 further comprising an elongate tongue extending from a forward edge of the trailer, the tongue having a coupler for connecting the trailer to a tow vehicle, wherein an aft edge of the trailer is positionable at a first distance from a ground surface when the control arm is positioned in the traveling position, and a second distance relative to the ground surface when the control arm is positioned in a kneeling position, the first distance being greater than the second distance when maintaining the coupler in a fixed position relative to the ground surface.
